(19) United States
(12) Patent Application Publication
(10) Pub. No.: US 2015/0022309 A1
(43) Pub. Date: Jan. 22, 2015

(54) MAGNETIC METAL-CONTAINING RESIN, AND COIL COMPONENT AND ELECTRONIC COMPONENT USING SAME

(71) Applicant: MURATA MANUFACTURING CO., LTD., Nagaokakyo-shi (JP)

(72) Inventor: Hiroshi Marusawa, Nagaokakyo-shi (JP)

(21) Appl. No.: 14/507,026

(22) Filed: Oct. 6, 2014

Related U.S. Application Data
(63) Continuation of application No. PCT/JP2013/059031, filed on Mar. 27, 2013.

(30) Foreign Application Priority Data
Apr. 26, 2012 (JP) 2012-101708

(51) Int. Cl. H01F 1/01; H01F 27/24

(52) U.S. Cl. CPC H01F 1/01; H01F 27/24
USPC 336/221; 252/62.55; 252/62.54

(57) ABSTRACT

A magnetic metal-containing resin that includes 70 to 88 mass % of a magnetic metal powder and 5.0 mass % or more of an oxide, and the oxide is 2.8 μm or more in average particle size. The magnetic metal-containing resin preferably includes 10 mass % or more of the oxide.

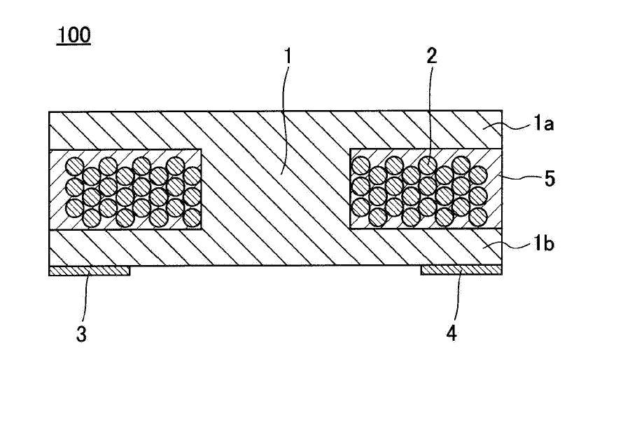

### CROSS REFERENCE TO RELATED APPLICATIONS

The present application is a continuation of International application No. PCT/JP2013/059031, filed Mar. 27, 2013, which claims priority to Japanese Patent Application No. 2012-101708, filed Apr. 26, 2012, the entire contents of each of which are incorporated herein by reference.

### FIELD OF THE INVENTION

This invention relates to a magnetic metal-containing resin including a mixture of a magnetic metal powder and a resin, as well as a coil component and an electronic component using the magnetic metal-containing resin.

### BACKGROUND OF THE INVENTION

Coil components including a drum-shaped core, a winding wound around the drum-shaped core, and an exterior resin layer formed between an upper flange and a lower flange of the drum-shaped core have been known as coil components for use in electronic devices. For example, as the coil component described in Patent Document 1, a winding-type inductor is disclosed which has a limited ratio between the diameter of a wound core and the external size of an upper flange. This coil component is characterized in that the proportion of an inorganic filler to a resin forming an exterior resin layer is 70 to 90 mass %. In addition, for this coil component, a coating material is disclosed which is characterized in that the inorganic filler is a spherical filler, and the proportion of the spherical filler is 20 mass % or more to the resin forming the exterior resin layer. The spherical filler included in the inorganic filler in the proportion mentioned above retains the fluidity of the exterior resin during filling, thus improving the productivity of the coil component. In addition, the resin forming the exterior resin layer, which includes the inorganic filler in the proportion mentioned above, can bring the linear expansion coefficient of the resin closer to that of the drum-shaped core, thereby resulting in the increased heat cycle resistance of the coil component.

However, in the case of the coating material as the exterior resin as described in Patent Document 1, the filling amount of the NiZn ferrite powder is on the order of 4.8 g/cm³ in true specific gravity, which means the large filling amount of the spherical filler, and thus, this resin has the problem of being unable to achieve any adequate magnetic permeability. In addition, when the exterior resin in Patent Document 1 is filled with the same spherical silica powder (on the order of 2.2 g/cm³), there is a problem that the filling volume allowed for soft magnetic metal powder will be decreased to obstruct the achievement of high magnetic permeability. Moreover, the ferrite (Fe-based oxide) described in Patent Document 1 has the problem of being relatively low in magnetic saturation, and likely to reach magnetic saturation due to direct-current superposition characteristics of the inductor.
Patent Document 1: Japanese Patent Application Laid-Open No. 2010-16217

### SUMMARY OF THE INVENTION

Therefore, a main object of this invention is to provide a magnetic metal-containing resin which can reduce magnetic saturation, and has thermal shock resistance that can withstand heating by application of direct-current bias and environmental temperatures, and a coil component and an electronic component using the resin.

The magnetic metal-containing resin according to this invention is a magnetic metal-containing resin characterized in that it includes 70 mass % to 88 mass % of a magnetic metal powder and 5.0 mass % or more of an oxide, and the oxide is 2.8 μm or more in average particle size.

In addition, the magnetic metal-containing resin according to this invention preferably includes the oxide to account for 10 mass % or more.

Furthermore, in the magnetic metal-containing resin according to this invention, the oxide is preferably 5.5 μm or more in average particle size.

Moreover, in the magnetic metal-containing resin according to this invention, the oxide is preferably a spherical silica powder.

In addition, in the magnetic metal-containing resin according to this invention, the total of the contents of the magnetic metal powder and oxide is preferably 94.7 mass % or more and 97.0 mass % or less.

Furthermore, in the magnetic metal-containing resin according to this invention, the linear expansion coefficient is preferably 20 ppm/° C. or less.

The coil component according to this invention is a coil component including: a drum-shaped core with an upper flange and a lower flange; a winding wound around the drum-shaped core; and a magnetic metal-containing resin layer formed between the upper flange and the lower flange, where the magnetic metal-containing resin layer is formed by applying the magnetic metal-containing resin according to this invention.

In addition, the electronic component according to this invention is an electronic component characterized in that it includes the magnetic metal-containing resin according to this invention.

The magnetic metal-containing resin according to this invention is a magnetic metal-containing resin including 70 to 88 mass % of magnetic metal powder and 5.0 mass % or more of oxide, where the oxide is 2.8 μm or more in average particle size. Thus, the resin is a resin which is high in saturation magnetization, and able to achieve a magnetic metal-containing resin which inhibits selective settling of metal particles of the magnetic metal powder due to a hindered settling phenomenon caused by the oxide, and has thermal shock resistance improved.

In addition, in the magnetic metal-containing resin according to this invention, the oxide is included to account for 10 mass % or more, or the oxide is 5.5 μm in average particle size. Thus, a magnetic metal-containing resin can be achieved which further inhibits selective settling of metal particles of the magnetic metal powder due to a hindered settling phenomenon caused by the oxide.

In addition, in the magnetic metal-containing resin according to this invention, the oxide is a silica powder, which thus can achieve a magnetic metal-containing resin reduced in linear expansion coefficient, and additionally, the oxide is spherical, and thus suitable for use as a shape-controlled filler for the magnetic metal-containing resin.

In addition, in the magnetic metal-containing resin according to this invention, when the total of the contents of the magnetic metal powder and oxide is 94.7 mass % or more and less than 97.0 mass %, selective settling of metal particles of the magnetic metal powder can be inhibited, and additionally, the linear expansion coefficient can be reduced. Moreover, when the linear expansion coefficient is reduced to 20 ppm/° C. or less, thermal stress in the magnetic metal-containing resin can be further reduced.

Furthermore, the coil component and electronic component according to this invention can, because of the use of the magnetic metal-containing resin according to this invention, optimize the content of the magnetic metal powder in the magnetic metal-containing resin within a range which will not degrade direct-current superposition characteristics of the winding chip coil, and due to the desired content of the spherical silica powder, achieve a coil component and an electronic component which inhibits settling of the magnetic metal, and has thermal shock resistance improved.

This invention can provide a magnetic metal-containing resin which can reduce magnetic saturation, and has thermal shock resistance that can withstand heating by application of direct-current bias and environmental temperatures, and a coil component and an electronic component using the resin.

The above-mentioned object, other objects, features, and advantages of this invention will be further evident from the following description with reference to the drawings.

### BRIEF EXPLANATION OF THE DRAWING

The FIGURE shows a schematic cross-sectional view of an embodiment of a coil component according to this invention.

### DETAILED DESCRIPTION OF THE INVENTION

An embodiment of a coil component will be described as an electronic component according to the present invention. The FIGURE is a schematic cross-sectional view of an embodiment of a coil component according to the present invention. The coil component according to the present invention is adapted to suppress settling of a magnetic metal and increase thermal shock resistance, in such a way that the content of the magnetic metal powder in a magnetic metal-containing powder is optimized within a range which will not degrade direct-current superposition characteristics of a winding chip coil, and the content of a spherical silica powder is adjusted to a desired content.

The coil component 100 shown in the FIGURE includes a drum-shaped core 1 with an upper flange 1a and a lower flange 1b, a winding 2 wound around the core 1, and a magnetic metal-containing resin layer 5 formed between the upper flange 1a and the lower flange 1b for sealing the winding 2.

The drum-shaped core 1 is formed from a magnetic body containing, for example, NiZnCu ferrite as its main constituent. Further, the drum-shaped core 1 is formed in, for example, a rectangle shape with a side of 3 mm in planar view. In addition, the upper flange 1a and lower flange 1b of the drum-shaped core 1 are, for example, each formed to be 0.2 mm in thickness. The material of the drum-shaped core 1 is preferably a magnetic material which is high in magnetic permeability.

For example, a copper wire of 0.2 mm in wire diameter with an insulating film is used for the winding 2. Further, the winding 2 is wound desired times between the upper flange 1a and the lower flange 1b.

External electrodes 3, 4 are formed on the surface of the lower flange 1b of the drum-shaped core 1. The material of the external electrodes 3, 4 is not particularly limited as long as the material is a metal for use as an electrode, but for example, alloys of silver, nickel, copper, and tin can be used. The external electrodes 3, 4 are electrically connected to the winding 2 by soldering or thermocompression bonding, or the like. Further, the coil component 100 is electrically connected through the external electrodes 3, 4 to a mounting substrate or the like.

The magnetic metal-containing resin layer 5 is, as described above, formed between the upper flange 1a and the lower flange 1b, for sealing the winding 2. The magnetic metal-containing resin layer 5 is formed from a magnetic metal-containing resin as described below.

Subsequently, the magnetic metal-containing resin according to the present invention will be described. The magnetic metal-containing resin includes a resin, a magnetic metal powder, and an oxide.

First, a cresol novolac-type epoxy resin is prepared as the resin. For the material of the resin, besides the cresol novolac-type epoxy resin, thermosetting resins and thermoplastic resins are used, such as bisphenol A epoxy resins, urethane resins, epoxy acrylate resins, phenol novolac-type epoxy resins, polyimide resins, silicone resins, fluorine resins, liquid crystal polymer resins, and polyphenyl sulfide resins. The cresol novolac-type epoxy resin herein is represented by the following structural formula (1).

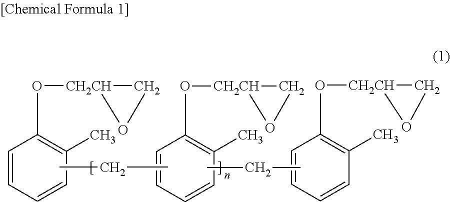

A permalloy powder (iron-nickel alloy) is prepared as a magnetic metal powder. The prepared permalloy powder has, as average particle sizes, a D50 value of, for example, 5.2 μm, and a D90 value of 14.9 μm, which is a magnetic metal powder. It is to be noted that the magnetic metal powder is not limited to the permalloy powder, but may be a Fe-based magnetic metal powder such as a crystalline Fe—Si—Cr metal powder, a Fe—Si—Cr amorphous powder, or a sendust magnetic powder.

For example, a spherical silica powder (SiO₂) is prepared as the oxide. The prepared oxide is preferably 2.8 μm or more, more preferably 5.5 μm or more in average particle size D50 as an oxide. In addition, a spherical silica powder is preferably used as the oxide. The use of the silica powder can reduce the linear expansion coefficient of the magnetic metal-containing resin, and thus bring the coefficient to the linear expansion coefficient of the drum-shaped core. In addition, the use of the spherical powder is suitable for use as a shape-controlled filler to the magnetic metal-containing resin. It is to be noted that the oxide is not limited to the spherical silica powder, but inorganic powders may be used such as spherical alumina, talc, calcium carbonate, and barium sulfate, or these powders may be used in combination. The oxide is added to prevent the settling of the magnetic metal in the magnetic metal-containing resin, and improve thermal shock resistance.

Subsequently, the prepared resin, magnetic metal powder, and oxide, as well as a curing agent, an organic solvent, a dispersant, and silane coupling are added, and agitated with, for example, a planetary mixer to prepare a magnetic metal-containing resin. The magnetic metal powder herein is preferably selected from the range of 70 mass % or more and 88 mass % or less for filling. This is because the powder less than 70 mass % decreases the magnetic permeability, thereby making it difficult to achieve the function as a magnetic body (for example, the function of improving the inductance value). Furthermore, this is because the powder in excess of 88 mass % reduces the resin component through the addition of 5.0 mass % or more of the oxide, thereby resulting in a fragile cured resin product. In addition, the oxide is preferably included to account for 5.0 mass % or more, more preferably 10 mass % or more.

The total of the additive amounts of the magnetic metal powder and oxide to the magnetic metal-containing resin is preferably 94.7 mass % or more and less than 97.0 mass %. The total of the additive amounts of the magnetic metal powder and oxide in this range can inhibit the selective settling of metal particles of the magnetic metal powder to stabilize the rate of increase in L value for the coil component, and lower the linear expansion coefficient to achieve the inhibition of thermal stress. Then, high reliability can be ensured for the obtained coil component. Further, the magnetic metal-containing resin preferably has a linear expansion coefficient 20 ppm/° C. or less.

A modified amine, a multifunctional phenol, an imidazole, mercaptan, an acid anhydride, or the like is used as the curing agent added to the magnetic metal-containing resin. In addition, a methyl acetate, an ethyl acetate, a methyl ethyl ketone, or the like is used as the organic solvent. Furthermore, a glycerin fatty acid, higher alcohol, or fatty acid ester compound is used as the dispersant.

The average particle size herein refers to a value measured by a laser diffraction/scattering method (Microtrac from Horiba, Ltd.). As the measurement method, each size is measured by the laser diffraction/scattering method after ultrasonic dispersion of the magnetic metal powder or oxide powder described above in an aqueous solution of sodium hexametaphosphate.

The coil component 100 according to this embodiment can ensure a high inductance value, because the selective settling of metal particles of the magnetic metal powder from a hindered settling phenomenon due to the spherical silica powder can be inhibited by mixing the magnetic metal-containing resin together with a spherical silica powder of 2.8 μm or more, more preferably 5.5 μm or more in terms of average particle size D50 value.

Furthermore, the coil component 100 according to this embodiment is configured to provide a satisfactory inductance value and direct-current superposition characteristics in such a way that the magnetic metal-containing resin obtained by kneading the magnetic metal powder with high saturation magnetization is applied to the winding 2 wound between the upper flange 1a and lower flange 1b of the coil component 100, subjected to curing, and the content of 5.0 mass % or more, preferably 10 mass % or more of the spherical silica powder mixed together in the magnetic metal-containing resin can bring the linear expansion coefficient close to the linear expansion coefficient (on the order of 10 ppm/° C.) of the ferrite core, and thus maintain the coefficient even in a heat cycle test for thermal shock (−40° C. to 125° C., 2000 cycles). More specifically, the increased filling rate of the oxide can inhibit crack generation during a heat cycle, which is caused by the difference in linear expansion coefficient between the drum-shaped core 1 and the magnetic metal-containing resin layer 5.

Thus, an electronic component as an inductor component can be provided which can reduce magnetic saturation, and has thermal shock resistance that can withstand heating by application of direct-current bias and environmental temperatures.

Next, a method will be described for manufacturing a coil component as an electronic component according to the present invention.

First, the drum-shaped core 1 is prepared. Specifically, first, a ferrite calcined powder such as NiZnCu ferrite is mixed with a binder, etc. to prepare ferrite slurry. Next, this ferrite slurry is subjected to granulation with the use of a spray dryer to prepare a ferrite granulated powder. Next, this granulated powder is subjected to press molding to prepare a compact. Finally, this compact is subjected to binder removal, and then to firing in accordance with a predetermined profile to obtain the drum-shaped core 1.

Next, the two external electrodes 3, 4 are formed on the lower surface of the lower flange 1b of the drum-shaped core 1 obtained. These external electrodes 3, 4 are formed by applying an Ag paste into a predetermined pattern, and baking the paste in the pattern at a predetermined temperature. Next, the winding 2 is provided between the upper flange 1a and the lower flange 1b of the drum-shaped core 1. Then, both ends of the winding 2 are respectively soldered on the external electrodes 3, 4. Next, the above-described magnetic metal-containing resin according to the present invention is applied onto the winding 2, and onto the drum-shaped core 1. Specifically, in accordance with the shape of the drum-shaped core 1 to which the magnetic metal-containing resin is to be applied, an organic solvent is additionally added to set the resin in an appropriate viscosity range, and the resin is applied to cover the winding 2. Then, finally, the magnetic metal-containing resin is heated to a predetermined temperature, and subjected to curing to form the magnetic metal-containing resin layer 5, thereby making it possible to prepare the desired coil component 100.

### EXPERIMENTAL EXAMPLES

Next, Experimental Examples 1, 2, and 3 will be described in which inductance values were measured on coil components filled with the magnetic metal-containing resin according to this invention. Samples of the magnetic metal-containing resins for use in the respective experimental examples were prepared to prepare the coil components filled with the samples.

### Experimental Example 1

In Experimental Example 1, as the magnetic metal-containing resins for use in coil components, samples 1 through 6 were prepared as follows. In Experimental Example 1, the samples were prepared by varying the average particle size of the spherical silica powder.

First, a cresol novolac-type epoxy resin was prepared as a resin for use in common from sample 1 to sample 6. A permalloy powder (Fe-45Ni) was prepared as a magnetic metal powder, whereas a spherical silica powder (SiO₂) was prepared as an oxide. Table 1 shows the respective contents of the spherical silica powder and permalloy powder included in the respective samples prepared in Experimental Example 1, and inductance values of the coil components, etc.

TABLE 1

| | Spherical Silica Powder | | | Permalloy Powder | | | | | | |
|---|---|---|---|---|---|---|---|---|---|---|
| | Average | Average | | Average | Average | | | Coil | | |
| | Particle | Particle | | Particle | Particle | | Particle | Component | | |
| | Size D50 | Size D90 | | Size D50 | Size D90 | | Size Ratio | L | Rate of | |
| | Value | Value | Content | Value | Value | Content | (Non- | value | Increase | |
| | μm | μm | mass % | μm | μm | mass % | Dimensional) | μH | % | Determination |
| Reference | — | — | 0 | — | — | 0 | — | 1.2 | — | |
| Sample | | | | | | | | | | |
| Sample 1 | — | 1.1 | 10.0 | 5.2 | 14.9 | 85 | — | 1.7 | 41.7 | X |
| Sample 2 | 2.8 | 4.4 | 10.0 | 5.2 | 14.9 | 85 | 0.5 | 2.0 | 66.7 | ◯ |
| Sample 3 | 5.5 | 15.2 | 10.0 | 5.2 | 14.9 | 85 | 1.1 | 2.2 | 83.3 | ◯ |
| Sample 4 | 8.0 | 26.1 | 10.0 | 5.2 | 14.9 | 85 | 1.5 | 2.2 | 83.3 | ◯ |
| Sample 5 | 15.0 | 40.3 | 10.0 | 5.2 | 14.9 | 85 | 2.9 | 2.2 | 83.3 | ◯ |
| Sample 6 | 20.0 | 48.2 | 10.0 | 5.2 | 14.9 | 85 | 3.8 | — | | X |

As shown in Table 1, the prepared permalloy powder for samples 1 through 6 was 5.2 μm in terms of average particle size D50 value and 14.9 μm in terms of average particle size D90 value. In addition, in samples 1 through 6, the content of the permalloy powder was adjusted to 85 mass %. Further, this permalloy powder was 160 Am²/kg in saturation magnetization.

In addition, the prepared spherical silica powder for sample 1 was 1.1 μm in terms of D90 value, while the average particle size D50 value was unmeasurable. Therefore, the particle size ratio is not calculated between the respective average particle size D50 values of the spherical silica powder for sample 1 and permalloy powder. The spherical silica powder for sample 2 was 2.8 μm in terms of average particle size D50 value, and 4.4 μm in terms of average particle size D90 value. Therefore, the particle size ratio was 0.5 between the respective average particle size D50 values of the spherical silica powder for sample 2 and permalloy powder. For sample 3, the average particle size D50 value was 5.5 μm, whereas the average particle size D90 value was 15.2 μm. Therefore, the particle size ratio was 1.1 between the respective average particle size D50 values of the spherical silica powder for sample 3 and permalloy powder. The spherical silica powder for sample 4 was 8.0 μm in terms of average particle size D50 value, and 26.1 μm in terms of average particle size D90 value. Therefore, the particle size ratio was 1.5 between the respective average particle size D50 values of the spherical silica powder for sample 4 and permalloy powder. The spherical silica powder for sample 5 was 15.0 μm in terms of average particle size D50 value, and 40.3 μm in terms of average particle size D90 value. Therefore, the particle size ratio was 2.9 between the respective average particle size D50 values of the spherical silica powder for sample 5 and permalloy powder. The spherical silica powder for sample 6 was 20.0 μm in terms of average particle size D50 value, and 48.2 μm in terms of average particle size D90 value. Therefore, the particle size ratio was 3.8 between the respective average particle size D50 values of the spherical silica powder for sample 6 and permalloy powder. In addition, in samples 1 through 6, the contents of the spherical silica powders were each adjusted to 10 mass %.

It is to be noted that in Experimental Example 1, the average particle sizes of the permalloy powder and spherical silica powder refer to a value measured by a laser diffraction/scattering method (Microtrac from Horiba, Ltd.). The respective average particle sizes were measured by the laser diffraction/scattering method after ultrasonic dispersion of the permalloy powder or spherical silica powder in an aqueous solution of sodium hexametaphosphate.

Then, 10 mass % of the cresol novolac-type epoxy resin, 85 mass % of the permalloy powder, and 10 mass % of the spherical silica powder were agitated with a planetary mixer for 5 to 8 hours, with the addition of 4 mass % of the curing agent, 10 mass % of the organic solvent, 0.2 mass % of the dispersant, and 0.5 mass % of the silane coupling agent, thereby preparing magnetic metal-containing resins for the respective samples.

Subsequently, the coil component for use in Experimental Example 1 herein was manufactured, for example, by the following method.

First, a drum-shaped core was prepared which was formed in a rectangle shape with a side of 3 mm and upper and lower flange thicknesses of 0.2 mm in planar view. Specifically, first, a ferrite calcined powder such as NiZnCu ferrite was mixed with a binder, etc. to prepare ferrite slurry. Next, this ferrite slurry was subjected to granulation with the use of a spray dryer to prepare a ferrite granulated powder. Next, this granulated powder was subjected to press molding to prepare a compact. Finally, this compact was subjected to binder removal, and then to firing in accordance with a predetermined profile to obtain a drum-shaped core.

Next, two external electrodes were formed on the bottom of the drum-shaped core obtained. These external electrodes were formed by applying an Ag paste into a predetermined pattern, and baking the paste in the pattern at a predetermined temperature. Next, a copper wire of 0.2 mm in wire diameter was wound for 13 turns around the drum-shaped core. Then, both ends of the winding were respectively soldered on the external electrodes. Next, the magnetic metal-containing resin for each sample of samples 1 through 6, prepared by the method described above, was applied onto the wiring, and onto the drum-shaped core. Specifically, in accordance with the shape of the drum-shaped core to which the magnetic metal-containing resin was to be applied, an organic solvent was additionally added to set the resin in an appropriate viscosity range, and the resin was applied to the winding. Then, finally, the magnetic metal-containing resin was heated to a predetermined temperature, and subjected to curing to form a magnetic metal-containing resin layer, thereby preparing a coil component. It is to be noted that in the case of sample 6, the nozzle for filling with the magnetic metal-containing resin was clogged, because the spherical silica powder included in the magnetic metal-containing resin was 48.2 μm in terms of average particle size D90 value, which correspond to 45 μm or more. Therefore, the magnetic metal-containing resin was not able to be applied to the drum-shaped core.

Further, for comparison with samples 1 through 6, a coil component to serve as a reference sample was prepared. This coil component to serve as a reference sample is a coil component without any magnetic metal-containing resin applied to the winding.

Subsequently, the inductance value was measured on each coil component of the reference sample as well as samples 1 through 6 according to Experimental Example 1. Table 1 shows the measurement results of the inductance value (L value) measured for each coil component, and the rate of increase in inductance value for each sample with respect to the inductance value for the reference sample. In addition, as criteria for determination, the rate of increase less than 50% was regarded as “X”, whereas the rate of 50% or more was regarded as “◯”. It is to be noted that the inductance values of the coil components for each sample were measured with HP 4291A from Hewlett-Packard Company.

In Experimental Example 1, the result of measuring the inductance value was 1.2 μH on the coil component as the reference sample. Furthermore, here are the measurement results for each sample. More specifically, in the case of sample 1, the inductance value of the coil component was 1.7 μH, and the rate of increase was 41.7% with respect to the inductance value of the coil component as the reference sample. In the case of sample 2, the inductance value of the coil component was 2.0 μH, and the rate of increase was 66.7% with respect to the inductance value of the coil component as the reference sample. In the case of samples 3 through 5, the inductance values of the coil components were all 2.2 μH, and the rates of increase were thus all 83.3% with respect to the inductance value of the coil component as the reference sample. It is to be noted that as for the coil component of sample 6, the inductance value was not measured, because the magnetic metal-containing resin was not able to be applied for the reason mentioned above.

The coil component of sample 1, in comparison with the coil component as the reference sample, has the improvement in inductance value because of including the permalloy powder as the magnetic metal powder, but has the rate of increase in inductance value less than 50% because of selective settlement of the magnetic metal, and thus an increased open magnetic circuit. In addition, sample 6 has failed to achieve favorable results, because, as described above, the nozzle for filling was clogged due to the fact that the spherical silica powder included in the magnetic metal-containing resin was 48.2 μm in terms of average particle size D90 value.

On the other hand, the coil component of sample 2 has achieved a high value of 50% or more for the rate of increase in inductance value, because the spherical silica powder added to the magnetic metal-containing resin is 2.8 μm in terms of average particle size D50 value, and the permalloy powder as the magnetic metal powder ensures high dispersibility due to a hindered settling phenomenon through the addition of the spherical silica powder. Furthermore, the coil components of samples 3 through 5 prevent selective settling of the magnetic metal, which is believed to be because the permalloy powder as the magnetic metal powder ensures higher dispersibility due to a hindered settling phenomenon caused by the spherical silica powder, due to the fact that the spherical silica powder is 5.5 μm or more in terms of average particle size D50 value, and the particle size ratio thereof is 1.1 or more in average particle size D50 value to the permalloy powder included in the magnetic metal-containing resin. In addition, in Experimental Example 1, the coil components with improvements in magnetic permeability were obtained because of the permalloy powder as the magnetic metal powder included to account for 85 mass %.

### Experimental Example 2

In Experimental Example 2, the following samples were prepared as magnetic metal-containing resins for use in coil components. In Experimental Example 2, as the magnetic metal-containing resins, the samples were prepared by varying the content of the permalloy powder.

First, a cresol novolac-type epoxy resin was prepared as a resin for use in common from sample 7 to sample 12. A permalloy powder (Fe-45Ni) was prepared as a magnetic metal powder. Table 2 shows the respective contents of the spherical silica powder and permalloy powder included in the respective samples prepared in Experimental Example 2, and inductance values of the coil components, etc.

TABLE 2

| | Spherical Silica Powder | | | Permalloy Powder | | | | | | |
|---|---|---|---|---|---|---|---|---|---|---|
| | Average | Average | | Average | Average | | | Coil | | |
| | Particle | Particle | | Particle | Particle | | Particle | Component | | |
| | Size D50 | Size D90 | | Size D50 | Size D90 | | Size Ratio | L | Rate of | |
| | Value | Value | Content | Value | Value | Content | (Non- | value | Increase | |
| | μm | μm | mass % | μm | μm | mass % | Dimensional) | μH | % | Determination |
| Reference | — | — | 0 | — | — | 0 | — | 1.2 | — | |
| Sample | | | | | | | | | | |
| Sample 7 | 5.5 | 15.2 | 5.0 | 5.2 | 14.9 | 65 | 1.1 | 1.6 | 33.3 | X |
| Sample 8 | 5.5 | 15.2 | 5.0 | 5.2 | 14.9 | 70 | 1.1 | 1.9 | 58.3 | ◯ |
| Sample 9 | 5.5 | 15.2 | 5.0 | 5.2 | 14.9 | 80 | 1.1 | 2.0 | 66.7 | ◯ |
| Sample 10 | 5.5 | 15.2 | 5.0 | 5.2 | 14.9 | 85 | 1.1 | 2.1 | 75.0 | ◯ |
| Sample 11 | 5.5 | 15.2 | 5.0 | 5.2 | 14.9 | 88 | 1.1 | 2.4 | 100.0 | ◯ |
| Sample 12 | 5.5 | 15.2 | 5.0 | 5.2 | 14.9 | 92 | 1.1 | 1.3 | 8.3 | X |

As shown in Table 2, the prepared permalloy powder for all of samples 7 through 12 was 5.2 μm in terms of average particle size D50 value and 14.9 μm in terms of average particle size D90 value. The contents of the permalloy powders in samples 7, 8, 9, 10, 11, and 12 were respectively 65 mass %, 70 mass %, 80 mass %, 85 mass %, 88 mass %, and 92 mass %. Further, this permalloy powder was 160 Am²/kg in saturation magnetization.

Further, the prepared spherical silica powder for all of samples 7 through 12 is 5.5 μm in average particle size D50 value, and 15.2 μm in average particle size D90 value. In addition, the contents of the spherical silica powder were adjusted to 5.0 mass %. Therefore, the particle size ratio was 1.1 between the respective average particle size D50 values of the spherical silica powder and permalloy powder for samples 7 through 12.

It is to be noted that in Experimental Example 2, the average particle sizes of the permalloy powder and spherical silica powder were also each measured by the laser diffraction/scattering method after ultrasonic dispersion of each powder in an aqueous solution of sodium hexametaphosphate.

Then, 10 mass % of the cresol novolac-type epoxy resin, each content of the permalloy powder for samples 7 through 12 as mentioned above, and 10 mass % of the spherical silica powder were agitated with a planetary mixer for 5 to 8 hours, with the addition of 4 mass % of the curing agent, 10 mass % of the organic solvent, 0.2 mass % of the dispersant, and 0.5 mass % of the silane coupling agent, thereby preparing magnetic metal-containing resins for the respective samples.

Subsequently, coil components were prepared in the same way as in Experimental Example 1. It is to be noted that for the magnetic metal-containing resins of the coil components prepared in Experimental Example 2, the resins of samples 7, 8, 9, 10, 11, and 12 were used and applied onto the windings to form magnetic metal-containing resin layers.

Subsequently, the inductance value was measured on each coil component of the reference sample as well as samples 7 through 12 according to Experimental Example 2. Table 2 shows the measurement results of the inductance value (L value) measured for the coil components as the respective samples, and the rate of increase in inductance value for each sample with respect to the inductance value for the reference sample. In addition, as criteria for determination, the rate of increase less than 50% was regarded as “X”, whereas the rate of 50% or more was regarded as “◯”. It is to be noted that the inductance values of the coil components for each sample were measured with HP 4291A from Hewlett-Packard Company.

Also in Experimental Example 2, the same coil component as in Experimental Example 1 with the inductance value of 1.2 μH as the reference sample was regarded as the reference sample. Furthermore, here are the measurement results for each sample. More specifically, in the case of sample 7, the inductance value of the coil component was 1.6 μH, and the rate of increase was 33.3% with respect to the inductance value of the coil component as the reference sample. In the case of sample 8, the inductance value of the coil component was 1.9 μH, and the rate of increase was 58.3% with respect to the inductance value of the coil component as the reference sample. In the case of sample 9, the inductance value of the coil component was 2.0 μH, and the rate of increase was 66.7% with respect to the inductance value of the coil component as the reference sample. In the case of sample 10, the inductance value of the coil component was 2.1 μH, and the rate of increase was 75.0% with respect to the inductance value of the coil component as the reference sample. In the case of sample 11, the inductance value of the coil component was 2.4 μH, and the rate of increase was 100% with respect to the inductance value of the coil component as the reference sample. In the case of sample 12, the inductance value of the coil component was 1.3 μH, and the rate of increase was 8.3% with respect to the inductance value of the coil component as the reference sample.

The coil component of sample 7, in comparison with the coil component as the reference sample, has the improvement in inductance value because of including the permalloy powder as the magnetic metal powder, but has the rate of increase in inductance value less than 50% because of the low content of the permalloy powder as the magnetic metal powder, and thus an increased open magnetic circuit. In addition, there is no significant difference in inductance value between the coil component of sample 12 and the coil component as the reference sample, because of bubble generation inside, due to the relatively high content of the permalloy powder as the magnetic metal powder included in the magnetic metal-containing resin, and also the spherical silica powder included in the magnetic metal-containing resin.

On the other hand, in the case of the coil components of samples 8, 9, 10, and 11, because of the content of the permalloy powder increased from 70 mass % to 88 mass % as the magnetic metal powder included in the magnetic metal-containing resin for each sample, the coil components with the inductance values improved have been achieved where the rate of increase in inductance value is 50% or more for all of the samples, with the increasing permalloy powder.

### Experimental Example 3

In Experimental Example 3, the following samples were prepared as magnetic metal-containing resins for use in coil components. In Experimental Example 3, the samples were prepared by varying each of the contents of the permalloy powder and spherical silica powder.

First, a bisphenol A epoxy resin was prepared as a resin for use in common from sample 13 to sample 18. A permalloy powder (Fe-45Ni) was prepared as a magnetic metal powder. Table 3 shows the respective contents of the spherical silica powder and permalloy powder included in the respective samples prepared in Experimental Example 3, properties of the magnetic metal-containing resin, and inductance values of the coil components, etc.

TABLE 3

| | | | | | | | | | Properties of | | | | |
|---|---|---|---|---|---|---|---|---|---|---|---|---|---|
| | | | | | | | | | Magnetic Metal- | | | | |
| | Spherical Silica Powder | | | Permalloy Powder | | | | Particle | containing Resin | | Coil | | |
| | Average | Average | | Average | Average | | Total of | Size | Linear | | Component | | |
| | Particle | Particle | | Particle | Particle | | Additive | Ratio | Expansion | | | Rate | |
| | Size D50 | Size D90 | | Size D50 | Size D90 | | Amounts | (Non- | Coeffi- | Bending | L | of In- | |
| | Value | Value | Content | Value | Value | Content | Content | Dimen- | cient | Strength | value | crease | Determi- |
| | μm | μm | mass % | μm | μm | mass % | mass % | sional) | ppm/° C. | MPa | μH | % | nation |
| Reference | — | — | 0 | — | — | 0 | 0 | — | — | — | 1.2 | — | |
| Sample | | | | | | | | | | | | | |
| Sample 13 | 5.5 | 15.2 | 10.5 | 5.2 | 14.9 | 82.0 | 92.5 | 1.1 | 39.6 | 58.4 | 2.4 | 100.0 | X |
| Sample 14 | 5.5 | 15.2 | 14.9 | 5.2 | 14.9 | 79.8 | 94.7 | 1.1 | 20.0 | 51.9 | 2.4 | 100.0 | ◯ |
| Sample 15 | 5.5 | 15.2 | 17.1 | 5.2 | 14.9 | 78.7 | 95.8 | 1.1 | 13.2 | 50.2 | 2.4 | 100.0 | ◯ |
| Sample 16 | 5.5 | 15.2 | 18.1 | 5.2 | 14.9 | 78.2 | 96.3 | 1.1 | 12.5 | 50.4 | 2.4 | 100.0 | ◯ |
| Sample 17 | 5.5 | 15.2 | 19.3 | 5.2 | 14.9 | 77.6 | 96.9 | 1.1 | 11.2 | 44.4 | 2.4 | 100.0 | ◯ |
| Sample 18 | 5.5 | 15.2 | 21.4 | 5.2 | 14.9 | 76.5 | 98.0 | 1.1 | 9.5 | 29.6 | 1.5 | 25.0 | X |

As shown in Table 3, the prepared permalloy powder for samples 13 through 18 was 5.2 μm in terms of average particle size D50 value and 14.9 μm in terms of average particle size D90 value. The contents of the permalloy powder in samples 13, 14, 15, 16, 17, and 18 were respectively 82.0 mass %, 79.8 mass %, 78.7 mass %, 78.2 mass %, 77.7 mass %, and 76.5 mass %. Further, this permalloy powder was 160 Am²/kg in saturation magnetization.

Further, the prepared spherical silica powder for all of samples 13 through 18 is 5.5 μm in average particle size D50 value, and 15.2 μm in average particle size D90 value. In addition, the contents of the spherical silica powder in samples 13, 14, 15, 16, 17, and 18 were respectively 10.5 mass %, 14.9 mass %, 17.1 mass %, 18.1 mass %, 19.3 mass %, and 21.4 mass %. The particle size ratio was 1.1 between the respective average particle size D50 values of the spherical silica powder and permalloy powder for samples 13 through 18.

It is to be noted that in Experimental Example 3, the average particle sizes of the permalloy powder and spherical silica powder were also each measured by the laser diffraction/scattering method after ultrasonic dispersion of each powder in an aqueous solution of sodium hexametaphosphate.

Then, 1.7 mass % to 6.4 mass % of the bisphenol A epoxy resin, each content of the permalloy powder for samples 13 through 18 as mentioned above, and each content of the spherical silica powder for samples 13 through 18 as mentioned above were agitated with a planetary mixer for 5 to 8 hours, with the addition of 0.4 mass % to 1.4 mass % of the curing agent, and further the organic solvent and the dispersant, thereby preparing magnetic metal-containing resins for the respective samples. It is to be noted that in Experimental Example 3, the total amount of the inorganic filler (the total content of the spherical silica powder and permalloy powder) in the magnetic metal-containing resin was adjusted to 92.5 mass % to 98.0 mass %

Subsequently, coil components were prepared in the same way as in Experimental Example 1. It is to be noted that for the magnetic metal-containing resins of the coil components prepared in Experimental Example 3, the resins of samples 13, 14, 15, 16, 17, and 18 were used and applied onto the windings to form magnetic metal-containing resin layers.

Subsequently, the inductance value was measured on each coil component of the reference sample as well as samples 13 through 18 according to Experimental Example 3. Table 3 shows the measurement results of the inductance value (L value) measured for the coil components as the respective samples, and the rate of increase in inductance value for each sample with respect to the inductance value for the reference sample. It is to be noted that the inductance values of the coil components for each sample were measured with HP 4291A from Hewlett-Packard Company.

Furthermore, in Experimental Example 3, a reliability test was carried out on the properties of the magnetic-metal-containing resin. For the reliability test, the linear expansion coefficient and bending strength were measured for each sample. For the linear expansion coefficient, test pieces of columnar cured products of 3 mm×3 mm×10 mm were each prepared from only the magnetic metal-containing resins for each sample, and the rate of elongation was measured while heating the test pieces at 5° C./min with the use of a thermo-mechanical analyzer (TMA: Thermal Mechanical Analysis). Further, for the bending strength, test pieces of cured products of 10 mm×50 mm×1 mm in thickness were each prepared from only the magnetic metal-containing resins for each sample, and the strength to fracture was measured while applying a pressure to the test pieces in the thickness direction.

As criteria for determination, the test piece with the rate of increase less than 50%, the linear expansion coefficient more than 20 ppm/° C., and the bending strength less than 30 MPa was regarded as “X”, whereas the test piece with the rate of increase of 50% or more, the linear expansion coefficient of 20 ppm/° C. or less, and the bending strength of 30 MPa or more was regarded as “◯”.

First, also in Experimental Example 3, the same coil component as in Experimental Example 1 with the inductance value of 1.2 μH as the reference sample was regarded as the reference sample. Furthermore, here are the measurement results for each sample. In the case of samples 13 through 17, the inductance values of the coil components were all 2.4 μH, and the rates of increase were 100.0% with respect to the inductance value of the coil component as the reference sample. On the other hand, in the case of sample 18, the inductance value of the coil component was 1.5 μH, and the rate of increase was 25.0% with respect to the inductance value of the coil component as the reference sample.

Next, from the reliability test according to Experimental Example 3, samples 13 through 17 undergo a reduction in linear expansion coefficient and a decrease in bending strength with the increased total of the inorganic filler. From the reliability test, each test piece of samples 14 through 17 has a low linear expansion coefficient of 20.0 ppm/° C. or less, and ensures bending strength of 40 MPa or more.

On the other hand, the test piece of sample 13 has a high linear expansion coefficient of 39.6 ppm/° C., and has thermal stress under elevated temperature, and it has been thus suggested that there is a possibility that the ferrite core will be pushed out to cause the ferrite core to suffer from a defective fracture. In addition, the test piece of sample 18 has low bending strength with the low strength of the magnetic metal-containing resin itself, and has further failed to ensure 50.0% or more, with the low rate of increase in L value, which is 25.0%.

It is to be noted that the magnetic metal-containing resin according to the embodiment of the present invention and the coil component coated with the magnetic metal-containing resin have been described. However, the present invention is not to be considered limited to the foregoing, but various changes can be made with the spirit of the invention.

More specifically, the electronic component coated with the magnetic metal-containing resin is not limited to the coil component, may be, for example, a noise filter. In addition, the structure of the electronic component may have a helical conductor pattern formed on the peripheral surface of the core, rather than the winding wound around the core. In addition, a substrate may be used in place of the core, and a conductor pattern may be formed on the substrate, and coated thereon with the magnetic metal-containing resin.

The present invention can be used in a preferred manner for coil components or electronic components for use in electronic devices, communication devices, etc.

### DESCRIPTION OF REFERENCE SYMBOLS

drum-shaped core
1a upper flange
1b lower flange
winding
3, 4 external electrode
5 magnetic metal-containing resin layer
100 coil component

1. A magnetic metal-containing resin comprising:
70 mass % to 88 mass % of a magnetic metal powder; and
5.0 mass % or more of an oxide,
wherein the oxide is 2.8 μm or more in average particle size.

2. The magnetic metal-containing resin according to claim 1, wherein the magnetic metal-containing resin comprises 10 mass % or more of the oxide.

3. The magnetic metal-containing resin according to claim 2, wherein the oxide is 5.5 μm or more in average particle size.

4. The magnetic metal-containing resin according to claim 1, wherein the oxide is 5.5 μm or more in average particle size.

5. The magnetic metal-containing resin according to claim 1, wherein the oxide is a spherical silica powder.

6. The magnetic metal-containing resin according to claim 1, wherein a total of contents of the magnetic metal powder and the oxide is 94.7 mass % or more and less than 97.0 mass %.

7. The magnetic metal-containing resin according to claim 1, wherein the magnetic metal-containing resin has a linear expansion coefficient of 20 ppm/° C. or less.

8. The magnetic metal-containing resin according to claim 1, further comprising a resin.

9. The magnetic metal-containing resin according to claim 1, wherein the resin is selected from the group consisting of cresol novolac-type epoxy resins, bisphenol A epoxy resins, urethane resins, epoxy acrylate resins, phenol novolac-type epoxy resins, polyimide resins, silicone resins, fluorine resins, liquid crystal polymer resins, and polyphenyl sulfide resins.

10. The magnetic metal-containing resin according to claim 1, wherein the magnetic metal powder is 5.2 μm or more in average particle size.

11. The magnetic metal-containing resin according to claim 1, wherein the magnetic metal powder is an Fe-based powder.

12. A coil component comprising:
a drum-shaped core having an upper flange and a lower flange;
a winding wound around the drum-shaped core; and
a magnetic metal-containing resin layer between the upper flange and the lower flange,
wherein the magnetic metal-containing resin layer is the magnetic metal-containing resin according to claim 1.

13. An electronic component comprising the magnetic metal-containing resin according to claim 1.
